(19) United States
(12) Patent Application Publication
(10) Pub. No.: US 2026/0147633 A1
(43) Pub. Date: May 28, 2026

(54) METHOD FOR PROVIDING AND MANAGING HYBRID AI SERVICES AND HYBRID AI CLOUD SYSTEM FOR PERFORMING THE SAME

(71) Applicant: AIEEV Inc., Daegu (KR)

(72) Inventor: Hyeon Kyeong KIM, Seoul (KR)

(21) Appl. No.: 19/400,729

(22) Filed: Nov. 25, 2025

(30) Foreign Application Priority Data
Nov. 27, 2024 (KR) 10-2024-0172720

(51) Int. Cl. G06F 9/50; G06F 11/20; G06F 11/30

(52) U.S. Cl. CPC G06F 9/5072; G06F 11/2028; G06F 11/3051; G06F 2209/501; G06F 2209/5011; G06F 2209/508

(57) ABSTRACT

A hybrid AI cloud system includes at least one distributed node configured to execute an artificial intelligence (AI) service, and a hybrid server configured to monitor the workload of a first distributed node configured to execute the AI service, and prepare in advance at least one second distributed node configured to assist or replace the first distributed node according to the result of the monitoring. The second distributed node is selected from a previously prepared distributed node pool including distributed nodes of the hybrid AI cloud system, or from a distributed node of an external cloud system. Through this, if there is a shortage of distributed nodes capable of executing AI services in the distributed cloud, distributed nodes included in a centralized cloud can be utilized, thereby achieving the advantages of both the distributed cloud and the centralized cloud.

### STATEMENT REGARDING SPONSORED RESEARCH OR DEVELOPMENT

The present disclosure is a research result by the support of the “Generative AI-based Infant Picture Diary Platform (Business Name: 2024 Initial Company SW Product Commercialization Support Project) (Ministry Name: Daegu Metropolitan City)” organized by the Daegu Digital Innovation Promotion Agency.

### CROSS REFERENCE TO RELATED APPLICATIONS

This application claims priority to Korean Patent Application No. 10-2024-0172720, filed on Nov. 27, 2024, in the Korean Intellectual Property Office, which is incorporated by reference herein in its entirety.

### FIELD OF DISCLOSURE

The present disclosure relates to a method for providing and managing a hybrid AI service and a hybrid AI cloud system for performing the same, and more particularly, to a method for providing and managing a hybrid AI service capable of simultaneously having advantages of both distributed and centralized clouds, and a hybrid AI cloud system for performing the same.

### BACKGROUND OF THE RELATED ART

A centralized AI cloud technology is used as a structure in which data processing and artificial intelligence (AI) model execution are performed in one central server or data center.

However, such a centralized AI cloud is not only easy to reach the limit of server capacity as throughput increases, but also tends to experience bottlenecks in large-scale AI computation operations. In particular, for applications requiring real-time processing, such as autonomous driving, the resulting delay may be fatal.

In addition, since the performance of the centralized AI cloud is heavily dependent on the state of network connection, network failures or connection instability can cause task interruptions or performance degradation, which represents a significant problem of high network dependence.

In particular, if a problem occurs in a central server or data center, the entire service may be interrupted or shut down, posing a serious threat to system stability and availability.

In order to solve these problems, a distributed cloud using distributed nodes is sometimes used to enable large-scale data processing by distributing computational tasks.

However, even distributed nodes provided in such distributed clouds may also lack the number of available nodes.

### SUMMARY OF THE INVENTION

The present disclosure has been made in an effort to solve the above-described problems, and an object of the present disclosure is to provide a method for providing and managing a hybrid artificial intelligence (AI) service, and a hybrid AI cloud system for performing the same, achieving both advantages of a distributed cloud and a centralized cloud by establishing a distributed cloud connecting distributed nodes capable of distributing and processing computation operations to provide an AI service, thereby resolving a single point failure, a bottleneck, and the like that may occur in a centralized cloud, and by utilizing distributed nodes included in the centralized cloud when there is a shortage of distributed nodes capable of executing the AI service in the distributed cloud.

According to an aspect of the present disclosure, a hybrid AI cloud system may include at least one distributed node configured to execute an artificial intelligence (AI) service, and a hybrid server configured to monitor a workload of a first distributed node configured to execute the AI service, and to prepare in advance at least one second distributed node configured to assist or replace the first distributed node according to a result of the monitoring. The at least one second distributed node may be selected from a previously prepared distributed node pool configured as a distributed node of the hybrid AI cloud system, or from a distributed node of an external cloud system.

In another embodiment of the present disclosure, the preparing of the at least one second distributed node in advance may include setting the second distributed node to be in a standby state equipped with AI execution environment information of the first distributed node.

In the other embodiment of the present disclosure, the hybrid server may prepare the at least one second distributed node in advance when the number of nodes that lack performance to execute the AI service among the first distributed nodes decreases to a preset threshold value or below, and the workload dynamically increases during a peak time.

In the other embodiment of the present disclosure, The hybrid server may receive a workload status of the first distributed node from the first distributed node when the first distributed node is a distributed node included in a fully-distributed cloud.

In the other embodiment of the present disclosure, The hybrid server may select the first distributed node to perform an AI service request pending in the AI service queue, and may deliver the AI service request to an execution queue of the first distributed node to be executed in the first distributed node.

According to another exemplary embodiment of the present disclosure, a method of providing and managing a hybrid AI service in a hybrid artificial intelligence (AI) cloud system may include providing at least one distributed node configured to execute an AI service, monitoring a workload of a first distributed node configured to execute the AI service, and preparing in advance at least one second distributed node configured to assist or replace the first distributed node according to a result of the monitoring. The at least one second distributed node may be selected from a previously prepared distributed node pool including distributed nodes of the hybrid AI cloud system, or from a distributed node of an external cloud system.

In the other embodiment of the present disclosure, the preparing of the at least one second distributed node in advance may include setting the at least one second distributed node to be in a standby state equipped with AI execution environment information of the first distributed node.

In the other embodiment of the present disclosure, the preparing of the at least one second distributed node in advance may include preparing the at least one second distributed node in advance when the number of nodes that lack performance to execute the AI service among the first distributed nodes decreases to a preset threshold value or below, and the workload dynamically increases during a peak time.

In the other embodiment of the present disclosure, the monitoring of the workload of the first distributed node may include receiving a workload status of the first distributed node from the first distributed node when the first distributed node is a distributed node included in a fully-distributed cloud.

In the other embodiment of the present disclosure, the method may further include, prior to the monitoring of the workload, including an AI service request in an AI service queue when the AI service request is received, selecting the first distributed node to perform the AI service request pending in the AI service queue, and delivering the AI service request to an execution queue of the first distributed node to execute the AI service request in the first distributed node.

According to one aspect of the present disclosure, by providing a method for providing and managing a hybrid artificial intelligence (AI) service and a hybrid AI cloud system for performing the same, the present disclosure can solve a single point failure, a bottleneck, and the like that may occur in a centralized cloud by constructing a distributed cloud by interconnecting distributed nodes capable of distributing and processing computational workloads to provide the AI service, and achieve the advantages of both the distributed cloud and the centralized cloud by utilizing distributed nodes included in the centralized cloud when there is a shortage of distributed nodes capable of executing the AI service in the distributed cloud.

### BRIEF DESCRIPTION OF THE DRAWINGS

FIG. 1 is a diagram illustrating a hybrid AI cloud system according to an embodiment of the present disclosure.

FIG. 2 is a diagram illustrating a case in which a hybrid server according to an embodiment of the present disclosure is configured as a central server.

FIGS. 3 to 8 are diagrams illustrating a process of preparing a second distributed node in advance when a hybrid server according to an embodiment of the present disclosure is provided as a central server.

FIG. 9 is a diagram illustrating a case in which a hybrid server according to an embodiment of the present disclosure is provided as a relay server,

FIGS. 10 and 11 are diagrams illustrating a process of providing an AI service when a hybrid server according to an embodiment of the present disclosure is provided as a relay server, and

FIG. 12 is a flowchart illustrating a method of providing and managing a hybrid AI service according to an embodiment of the present disclosure.

### DETAILED DESCRIPTION OF THE PREFERRED EMBODIMENT

A detailed description of the present disclosure, which will be described later, refers to the accompanying drawings, which illustrate specific embodiments in which the present disclosure may be practiced as examples. These examples are described in detail to be sufficient for those skilled in the art to practice the present disclosure. It should be understood that the various embodiments of the present disclosure are different from each other but need not be mutually exclusive. For example, certain shapes, structures, and characteristics described herein may be implemented in other embodiments without departing from the spirit and scope of the present disclosure with respect to one embodiment. It should also be understood that the position or arrangement of individual components within each disclosed embodiment may be altered without departing from the spirit and scope of the present disclosure. Accordingly, the detailed description to be described below is not intended to be taken in a limited sense, and the scope of the present disclosure, if properly described, is limited only by the appended claims along with all the scope equivalent to those claimed by the claims. Similar reference numerals in the drawings refer to the same or similar functions across several aspects.

The components according to the present disclosure are components defined by functional classification rather than physical classification, and may be defined by functions performed by each. Each component may be implemented as hardware or a program code and a processing unit that perform each function, and functions of two or more components may be included in one component to be implemented. Accordingly, it should be noted that the names given to the components in the following embodiments are not intended to physically distinguish each component, but are given to imply a representative function in which each component is performed, and the technical spirit of the present disclosure is not limited by the names of the components.

Hereinafter, exemplary embodiments of the present disclosure will be described in more detail with reference to the drawings.

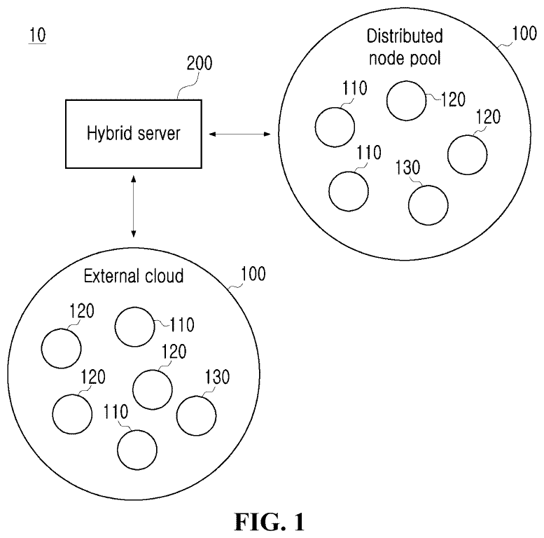

FIG. 1 is a diagram illustrating a hybrid AI cloud system 10 according to an embodiment of the present disclosure.

The hybrid AI cloud system 10 (hereinafter, referred to as a system) according to the present embodiment may stably provide and manage an AI service by simultaneously having advantages of both distributed and centralized clouds.

The system 10 according to the present embodiment may include at least one distributed node 100 and a hybrid server 200. In addition, the at least one distributed node 100 and the hybrid server 200 may be configured such that software (applications) for performing the hybrid AI service providing and managing method may be installed and executed, and the at least one distributed node 100 and the hybrid server 200 may be controlled by software (applications) for performing the hybrid AI service providing and managing method.

In this case, the at least one distributed node 100 and the hybrid server 200 may be separate terminals or some modules of the terminals.

In addition, the at least one distributed node 100 and the hybrid server 200 may have mobility or may be fixed. The at least one distributed node 100 and the hybrid server 200 may be in the form of a device, a server, or an engine, and may be referred to as other terms such as a device, an appliance, a terminal, a user equipment (UE), a mobile station (MS), a wireless device, a handheld device, and the like. The device 100 may execute or manufacture various software based on an OS (Operating System), that is, a system. Here, the operating system is a system program for enabling software to use hardware of a device, and may include all of mobile computer operating systems such as Android OS, iOS, Windows mobile OS, Bada OS, Symbian OS, and BlackBerry OS, and computer operating systems such as Windows, Linux, Unix, MAC, AIX, and HP-UX.

First, at least one distributed node 100 according to an embodiment of the present disclosure may execute the AI service according to the pre-configured artificial intelligence (AI) service execution environment information.

Here, the AI service execution environment information prepared in advance is information stored in the AI execution environment storage prepared in advance, and may be downloaded from the AI execution environment storage 300 in advance and provided.

In addition, at least one distributed node 100 according to the present embodiment may include a first distributed node 110, a second distributed node 120, and a third distributed node 130.

The first distributed node 110, the second distributed node 120, and the third distributed node 130 may be classified according to states.

Specifically, the first distributed node 110 is a node in a running state among the at least one distributed node 100 and may mean a node in a state in which an actual AI service is being executed.

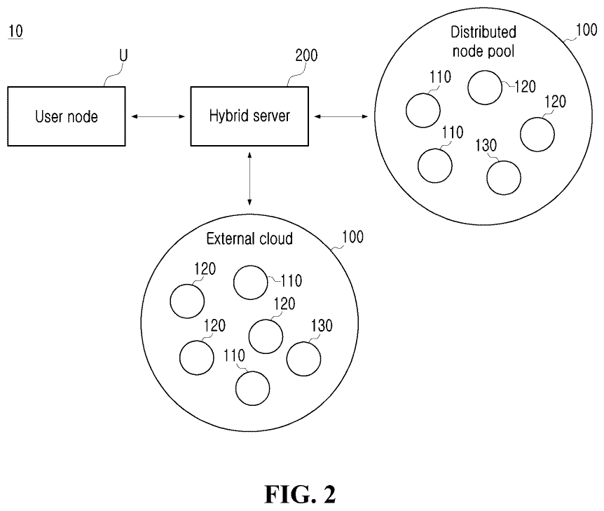

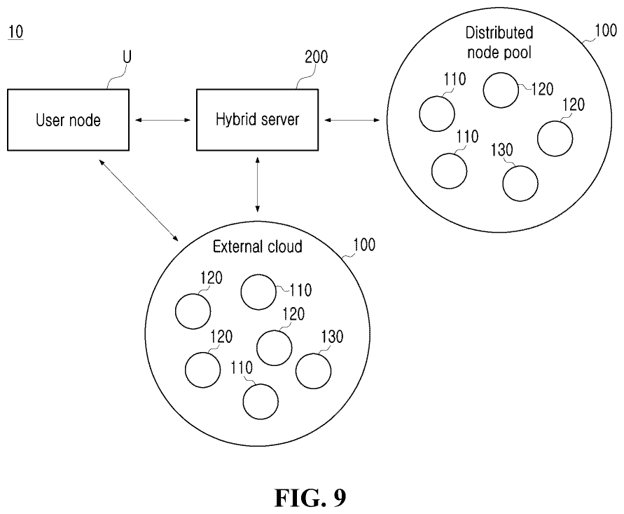

In addition, the first distributed node 110 may transmit its workload status to the hybrid server 200 according to the type of the hybrid server 200. In this regard, it will be described later together with the hybrid server 200 in FIGS. 2 and 9 to be described later.

Meanwhile, the second distributed node 120 is a node in a ready state among the at least one distributed node 100, and may refer to a node in a ready state in which at least one AI service execution environment information is provided in advance to perform the AI service.

As shown in FIG. 1, the second distributed node 120 may be selected from a previously prepared distributed node pool including distributed nodes of the system 10 according to the present embodiment, or may be selected from distributed nodes of an external cloud system.

Meanwhile, the third distributed node 130 does not include AI execution environment information, but may refer to any node that satisfies resources for AI service execution and may be selected as the second distributed node 120 if necessary.

In the system 10 according to the present embodiment including the at least one distributed node 100, the second distributed node 120 may be selected from among the third distributed nodes 130 according to a preset condition, and the first distributed node 110 may be selected from among the second distributed nodes 120.

Meanwhile, the hybrid server 200 (hereinafter, referred to as a server) according to the present embodiment may monitor a workload of the first distributed node 110 executing the AI service.

In addition, the server 200 may prepare in advance at least one second distributed node 120 to assist or replace the first distributed node 110 according to the result of the workload monitoring. The server 200 may prepare the second distributed node 120 in advance when it is determined that the first distributed node 110 currently executing the AI service is likely to become insufficient.

Further, the server 200 preparing the second distributed node 120 in advance may be setting the second distributed node 120 to be in a standby state having or being equipped with the AI execution environment information of the first distributed node 110.

To this end, the server 200 may select at least one or more second distributed nodes 120 from a previously prepared distributed node pool configured as distributed nodes of the hybrid AI cloud system 10 as shown in FIG. 1, or from a distributed node of an external cloud system.

Here, the external cloud system is a system including a centralized cloud, a distributed cloud, or a fully-distributed cloud, and may refer to a cloud system external to the system 10 of the present embodiment.

Accordingly, the server 200 according to the present embodiment may use, as needed, at least one distributed node 100 constituting a node of a centralized cloud or a fully-distributed cloud.

To this end, the server 200 according to the present embodiment may be configured to operate in at least one of a central server mode and a relay server mode.

FIG. 2 is a diagram illustrating a case in which the server 200 according to the present embodiment is operated in a central server mode.

First, as illustrated in FIG. 2, when the server 200 is operated in a central server mode, the server 200 may receive an AI service request from the user node U, and transmit or deliver the received AI service request to the first distributed node 110, so that the first distributed node 110 executes the AI service.

In addition, when driven in a central server mode, the server 200 may monitor the workload of the first distributed node 110 according to the AI service request received from the user node U.

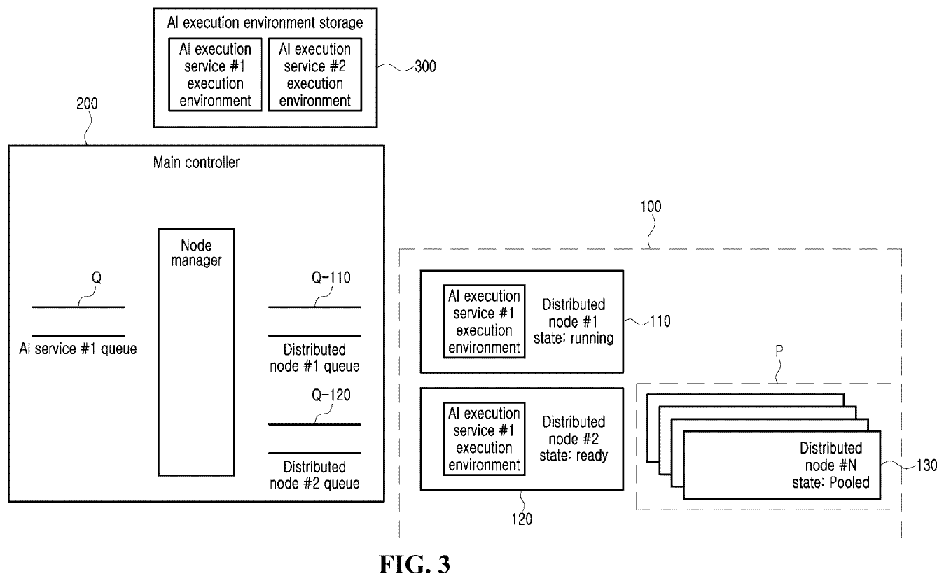

Meanwhile, FIGS. 3 to 8 are diagrams illustrating a process in which the server 200 according to the present embodiment is operated in a central server mode as shown in FIG. 2 and prepares the second distributed node 120 in advance among the distributed node 100 constituting the distributed cloud.

The server 200 may prepare the second distributed node 120 to assist or replace the first distributed node 110 as an available node at any time, and a condition for preparing the second distributed node 120 in advance may be provided in advance.

Specifically, when it is determined that the number of nodes having insufficient performance to execute the AI service among the first distributed nodes 110 is reduced to be less than or equal to a preset threshold value and that the workload dynamically increases during a peak time, the server 200 may prepare the second distributed node 120 in advance. Here, the peak time may be computed as an average over a preset time window by measuring the usage amount during a preset unit period.

In addition, the server 200 may determine the peak time when the request amount of the user node U requesting the specific AI service is greater than the preset request amount for the unit time, but is not necessarily limited thereto.

As another example, the server 200 may also prepare the second distributed node 120 in advance when the number of second distributed nodes 120 having a ready state by including the AI service execution environment information is reduced to a predetermined number or less, and the third distributed node 130 that may be selected as the second distributed node 120 is absent.

That is, when the above conditions are met and no distributed node capable of assisting or replacing the first distributed node 110 exists within the system 10 according to the present embodiment, the server 200 according to the present embodiment may prepare the distributed node of the external cloud system as the second distributed node 120.

In order to prepare the second distributed node 120 in advance, the server 200 may dynamically allocate a distributed node capable of executing an AI service through a container orchestration tool such as Kubernetes.

Hereinafter, a process in which the system 10 according to the present embodiment dynamically allocates the distributed node 100 will be described in detail with reference to FIGS. 3 to 8.

For convenience of description, a case in which the system 10 according to the present embodiment is a system based on a distributed cloud, and the server 200 driven in a central server mode additionally selects a distributed node in an external cloud system configured as a centralized cloud will be described as an example.

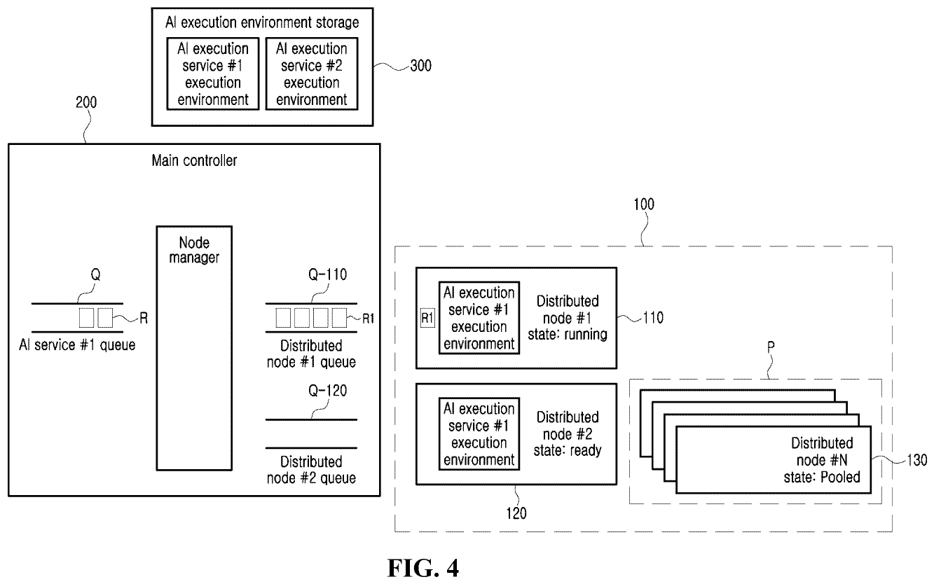

Specifically, FIGS. 3 and 4 are diagrams illustrating a process in which the first distributed node 110 executes the AI service.

As shown in FIG. 3, in the system 10 configured as a distributed cloud, the server 200 may include an AI service queue Q for each AI service.

As illustrated in FIG. 4, the server 200 may select the first distributed node 110 to perform the AI service request R pending in the AI service queue Q, and may transmit the AI service request R to the execution queue Q-110 for execution on the first distributed node 110.

To this end, the server 200 may include a node manager that determines the first distributed node 110 to execute the AI service request R included in the AI service queue Q provided for each AI service.

In addition, the server 200 may provide at least one second distributed node 120 to assist or replace the first distributed node 110, and set the second distributed node 120 to be in a standby state having AI execution environment information of the first distributed node 110.

That is, when the AI service executed by the first distributed node 110 is the first AI service, the server 200 may allow the second distributed node 120 to have the first AI service execution environment information capable of executing the first AI service in advance.

In addition, when the first distributed node 110 lacks performance to execute the AI service and thus needs assistance, the server 200 may transmit the AI service request R pending in the AI service queue Q to the execution queue Q-120 of the second distributed node 120.

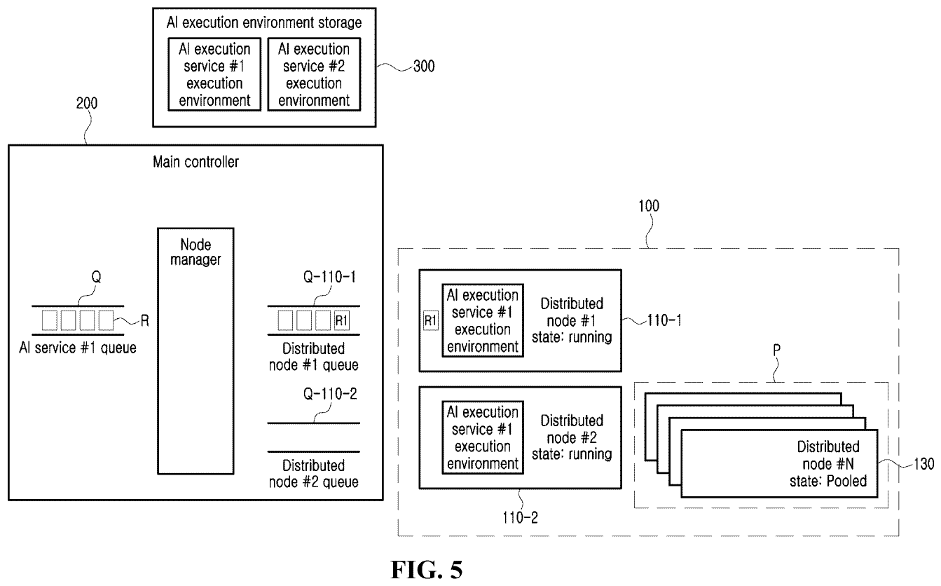

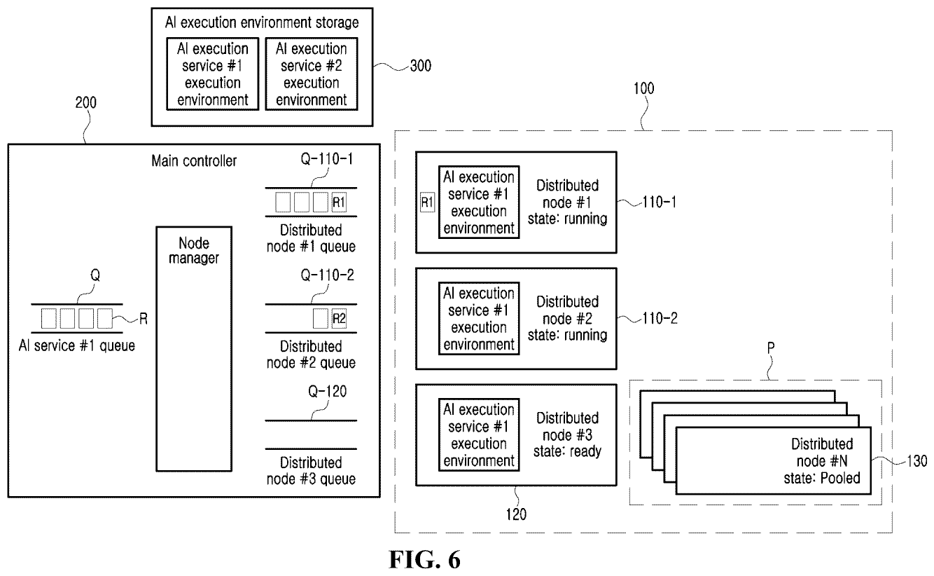

Specifically, FIGS. 5 and 6 are diagrams illustrating a process of executing the AI service in the system 10 when the performance of the first distributed node 110 is insufficient.

In the present embodiment, when assistance of the first distributed node 110 is required, as illustrated in FIG. 5, the number of AI service requests R1 pending in the execution queue Q-110 of the first distributed node 110 exceeds a preset threshold and remains for a predetermined time period or longer. That is, the number R1 of AI service requests allocated to the execution queue Q-110 of the first distributed node 110 may be N or more, and a state of N or more may be accumulated for T time or more.

As shown in FIG. 5, this may mean a case in which the number of AI service requests R pending in the AI service queue Q is accumulated for a predetermined time or longer by more than a preset threshold value. In other words, when the AI service allocated to the first distributed node 110 exceeds a preset request-per-second threshold, the server 200 may prepare the second distributed node 120 in advance.

As described above, when it is determined that assistance of the first distributed node 110 is required, the server 200 may change the second distributed node 120 in the ready state, as shown in FIG. 4, to the running state, as shown in FIG. 5, and set the first distributed node 110-2.

In addition, the server 200 may transmit the AI service request R pending in the AI service queue Q to the execution queue Q-110-2 of the first distributed node 110-2 changed to the running state, as shown in FIG. 4.

Accordingly, the server 200 may provide the AI service through the plurality of first distributed nodes 110-1 and 110-2 executing the same AI service.

In addition, the server 200 according to the present embodiment may allow the AI service request R1 to be included in the execution queue Q-110 of the first distributed node until the AI service execution result for the AI service request R1 of the first distributed node 110 is received from the first distributed node 110.

In other words, the server 200 does not delete the AI service from the execution queue Q-110-1 of the first distributed node 110-1 until the AI service for the AI service request R1 included in the execution queue Q-110-1 of the first distributed node 110-1 is provided. Whether to provide the AI service may be determined through a process in which the server 200 receives an ACK message for processing completion from the first distributed node 110-1 or receives a response message from the user node U receiving the AI service.

In addition, when the server 200 sets the previous second distributed node 120 to the first distributed node 110-1 by changing the state of the second distributed node 120 to the running state, as shown in FIG. 5, the server 200 may select at least one of the third distributed nodes 130 registered in the pre-established distributed node pool P as the second distributed node 120, as shown in FIG. 6.

In addition, the server 200 may allow a node selected as the second distributed node 120 from among the third distributed nodes 130 to be equipped with AI execution environment information of the first distributed nodes 110-1 and 110-2, and to be in a standby state.

Through this process, when it is determined that the number of available nodes including the second distributed node 120 and the third distributed node 130 is equal to or less than a predetermined number, and the average value of the usage of the distributed nodes during the unit period exceeds a preset threshold and is a peak time, the server 200 may prepare at least one third distributed node 130 included in the external cloud system including the distributed cloud as the second distributed node 120, as illustrated in FIG. 2.

That is, as shown in FIG. 6, when the third distributed node 130 to be selected as the second distributed node 120 is insufficient in the distributed node pool P of the system 10 according to the present embodiment, the server 200 may select the distributed node of the external cloud system as the second distributed node 120.

In addition, when the external cloud system is configured as a centralized cloud, the centralized cloud itself or a part of resources constituting the centralized cloud may be prepared as the second distributed node 120 in order to use the corresponding centralized cloud as a distributed node.

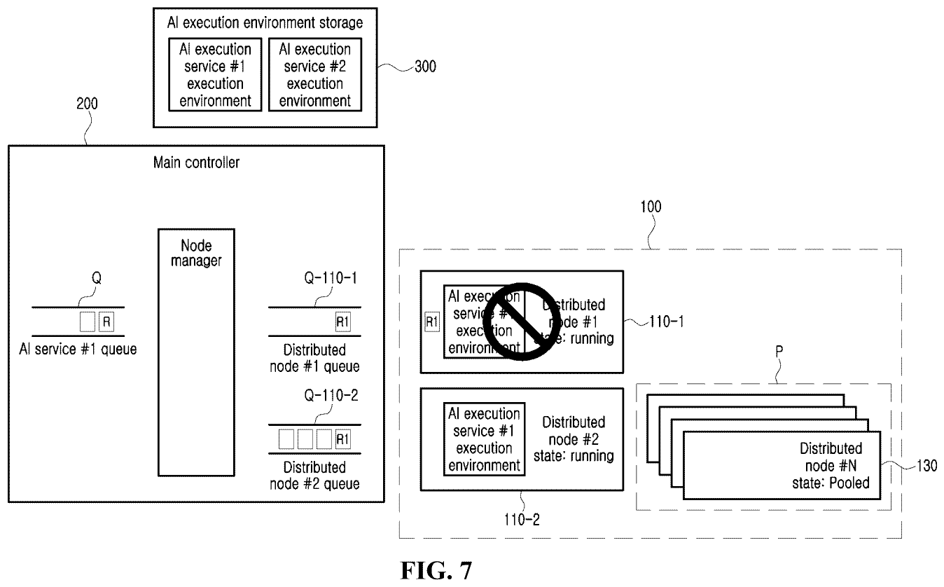

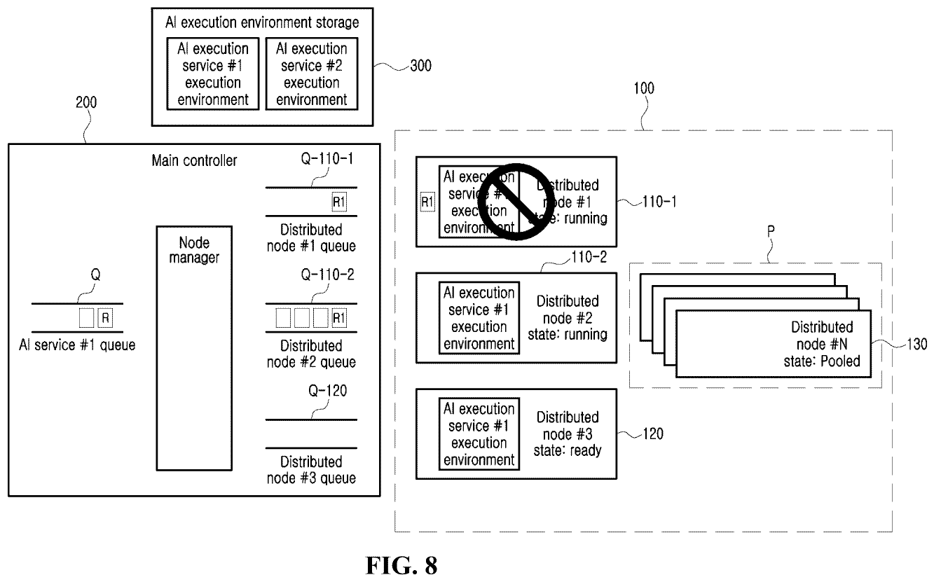

FIGS. 7 and 8 are diagrams illustrating a process of executing an AI service when a failure occurs in the first distributed node 110.

The server 200 according to the present embodiment may periodically receive a health-check signal from the first distributed node 110 currently executing the AI service to manage the AI service.

In addition, when the health-check signal is not received from the first distributed node 110 within a preset period, the server 200 may determine that the corresponding first distributed node 110 is determined to be faulty, as shown in FIG. 7.

Accordingly, when it is determined that the first distributed node 110 is failed, the server 200 may set the second distributed node 120 in the standby state as the first distributed node 110-2 through the above-described process, as shown in FIG. 8. In addition, the server 200 may transfer the AI service request R1 pending in the execution queue Q-110-1 of the first distributed node 110-1 determined to be faulty to the execution queue Q-110-2 of another first distributed node 110-2. As described above, the case where the first distributed node 110-1 is determined to be faulty may mean a case where the second distributed node 120 has to replace the first distributed node 110.

In addition, as shown in FIG. 8, the server 200 may select the third distributed node 130 from the distributed node pool P and designate it as the second distributed node 120. If there is no third distributed node 130 that may be selected from the distributed node pool P, as described above, a node of the external cloud system may be selected as the second distributed node 120. Such an external cloud system may be at least one of a centralized cloud and a distributed cloud.

Accordingly, the system 10 according to the present embodiment may have advantages of both the distributed cloud and the centralized cloud by constructing a distributed cloud through connecting distributed nodes capable of distributing and processing operation tasks to provide an AI service, solving a single point failure, a bottleneck, and the like that may occur in the centralized cloud, and by using distributed nodes included in the centralized cloud when there is a shortage of distributed nodes capable of executing an AI service in the distributed cloud.

Meanwhile, the AI execution environment storage 300 may also be provided to store AI execution environment information, which is information for executing an AI service provided and managed by the system 10 according to the present embodiment.

Accordingly, the storage 300 according to the present embodiment may include AI service execution environments provided for different AI services as shown in FIGS. 3 to 8, and may transmit AI service execution environment information requested by at least one distributed node 100 according to a request of at least one distributed node 100.

Meanwhile, FIG. 9 is a diagram illustrating a case in which the server 200 according to the present embodiment is operated in a relay server mode.

As illustrated in FIG. 9, when the server 200 is operated in the relay server mode, the user node U may directly transmit the AI service request to the first distributed node 110 without transmitting the AI service request to the server 200.

The server 200 operated in the relay server mode may receive the workload status of the first distributed node 110 from the first distributed node 110, unlike the case in which the server 200 is driven by the above-described central server mode. This is because the first distributed node 110 is a distributed node constituting a fully-distributed cloud.

Accordingly, as illustrated in FIG. 9, even though the system 10 according to the present embodiment is configured as a distributed cloud system and the external cloud system is configured as a fully-distributed cloud, the server 200 according to the present embodiment may monitor the workload status of the first distributed node 110 by receiving the workload status from the first distributed node 110 included in the external cloud.

That is, when the present system 10 is configured as a distributed cloud system, as described above, the distributed node 100 constituting the distributed cloud may operate in a central server mode, but when the external cloud system is provided as a fully-distributed cloud, the system may operate in a relay server mode.

The process of preparing a second distributed node 120 among the distributed nodes 100 constituting the distributed cloud by the server 200 according to the present embodiment is sufficiently described with reference to FIGS. 2 to 8, and thus a detailed description thereof will be omitted.

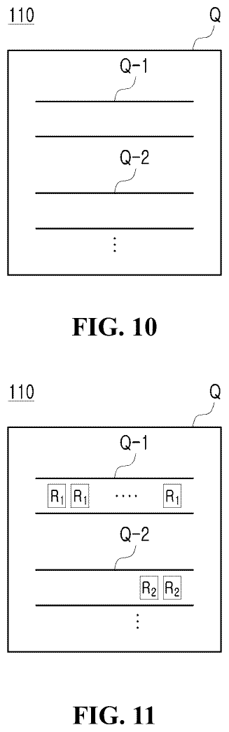

Hereinafter, a case in which the server 200 operating in the relay server mode according to the present embodiment provides the AI service through the first distributed node 110 or prepares the second distributed node 120 in an external cloud system configured as a fully-distributed cloud will be described with reference to FIGS. 10 and 11.

FIGS. 10 and 11 are diagrams illustrating a process in which an AI service is provided when a hybrid server is provided as a relay server according to an embodiment of the present disclosure.

Hereinafter, for convenience of description, a process in which the server 200 operating as a relay server of the present embodiment utilizes the distributed node 100 of an external cloud system configured as a fully-distributed cloud will be mainly described.

First, the server 200 operating in the relay server mode may receive and register distributed node information in advance from the distributed node 100 constituting the external cloud system.

The distributed node information may include at least one of its own access information for the user node U to access, its own performance information, and AI execution environment information.

Here, the access information may include an IP address and a port.

The performance information may include information related to the type of resources available for executing the AI service, for example, information on GPU types and specifications.

The AI execution environment information is information provided in advance for execution of a specific AI service. If the distributed node 100 does not include AI execution environment information, the corresponding information may be omitted.

As shown in FIGS. 10 and 11, the distributed node 100 constituting a fully-distributed external cloud may include an execution queue Q, and the execution queue Q may be provided for each AI service unit.

In addition, the first distributed node 110 may transmit an overload message to the server 200 when the number of AI service requests included in the execution queue Q exceeds a preset threshold value.

Specifically, as illustrated in FIGS. 10 and 11, the first distributed node 110 may include a first execution queue Q-1 for executing a first AI service and a second execution queue Q-2 for executing a second AI service in order to execute different AI services.

Accordingly, when the sum of the number of the first AI service requests R1 and the number of the second AI service requests R2 pending in the first and second execution queues Q-1 and Q-2 exceeds a preset threshold value, the first distributed node 110 may transmit an overload message to the server 200.

Of course, this is merely an example for convenience of description, and even when at least one of the number of first AI service requests R1 included in the first execution queue Q-1 or the number of second AI service requests R2 included in the second execution queue Q-2 exceeds a preset threshold value, the first distributed node 110 may transmit an overload message to the relay server.

In addition, although it has been described that the plurality of execution queues Q are provided according to the type of AI service to be executed, they may be provided for each user node U unit rather than for the type of AI service.

In addition, the first distributed node 110 may transmit, to the server 200, a workload calculated as the number of AI service requests and a processing time for each AI service unit. Here, as described above, the workload may be calculated for each AI service unit as well as for each user node U unit.

Meanwhile, the second distributed node 120 may refer to a node having the resources to execute the AI service but not having AI execution environment information for AI service execution.

The second distributed node 120 may receive a request from the server 200 to include AI execution environment information for AI service execution.

Accordingly, the second distributed node 120 may download and provide the requested AI execution environment information from a storage in which AI execution environment information provided in advance inside or outside the system 10 is stored.

That is, although the first distributed node 110 and the second distributed node 120 have been described for convenience of description in the present embodiment, the first distributed node 110 may refer to the second distributed node 120 having AI execution environment information among the second distributed nodes 120 and receiving an AI service request from the user node U.

In addition, the server 200 operated in the relay server mode according to the present embodiment may receive request condition information for executing the AI service from the user node U. Accordingly, the server 200 may select the first distributed node 110 corresponding to the received request condition information.

Here, the request condition information may include a type of an AI service that the user node U desires to receive, a type of a resource required to receive an AI service such as a GPU type, and the like.

In addition, the server 200 according to the present embodiment may receive the overload message from the first distributed node 110 executing the AI service.

Accordingly, the server 200 may exclude the first distributed node 110 that has transmitted the overload message in the process of selecting the first distributed node 110.

The first distributed node 110 that has transmitted the overload message may be excluded from selection until the reported workload by the first distributed node 110 becomes less than or equal to a preset threshold value. Here, the preset threshold value may be set based on the AI service execution speed, execution time, and throughput based on the resource performance of the corresponding first distributed node 110, and may be dynamically adjusted.

In addition, in the process of selecting the first distributed node 110, when the first distributed node 110 does not exist, the server 200 may transmit, to the user node U, access information of the second distributed node 120 that does not include the AI execution environment information among the at least one distributed node 100.

In addition, the server 200 may request the second distributed node 120 to include the AI execution environment information corresponding to the request condition information before, after, or simultaneously with transmitting the access information of the second distributed node 120 to the user node U.

Accordingly, the second distributed node 120 requested to include the AI execution environment information may download the AI execution environment information for executing the AI service requested by the user node U from the storage and acquire the same as described above.

In addition, the server 200 may transmit the access information of the selected first distributed node 110 to the user node U.

The server 200 may manage user node information allocated to the first distributed node 110.

For example, the server 200 may prepare and manage a lookup table in which distributed node information of at least one distributed node 100 and user node information such as a service ID of a user node U allocated to each distributed node 100 are matched. Such a lookup table may include information on an overload message, a workload, or the like.

In addition, when the user node U determines that the first distributed node 110 is determined to be faulty, the server 200 according to the present embodiment may re-receive the request condition information from the corresponding user node U.

Accordingly, when re-receiving the request condition information, the server 200 may select the first distributed node 110 or the second distributed node 120 capable of replacing the corresponding first distributed node 110 and transmit the access information of the corresponding distributed node 100 to the user node U.

Through this mechanism, even if the server 200 according to the present embodiment does not receive the overload message from the first distributed node 110 due to a problem in the first distributed node 110, the server 200 may re-receive the request condition information from the user node U according to the timeout from the first distributed node 110, thereby recognizing the problem with the first distributed node 110.

Through the hybrid server 200 according to the present embodiment that may be driven by the above-described central server and relay server mode, the system 10 according to the present embodiment may have advantages of both a distributed cloud and a centralized cloud.

Meanwhile, FIG. 12 is a flowchart illustrating a method for providing and managing a hybrid AI service according to an embodiment of the present disclosure. Since the method of providing and managing a hybrid AI service according to an embodiment of the present disclosure is performed in substantially the same configuration as the system 10 illustrated in FIG. 1, the same reference numerals are assigned to the same components as those of the system 10 of FIG. 1, and repeated descriptions thereof will be omitted.

The method for providing and managing the hybrid AI service according to the present embodiment includes preparing a distributed node S110, monitoring a workload S130, and preparing a second distributed node in advance S150.

In the step S110 of preparing the distributed node, the system 10 may prepare at least one distributed node 100 for executing the AI service.

Meanwhile, in the step S130 of monitoring the workload, the server 200 may monitor the workload of the first distributed node 110 executing the AI service.

In the monitoring of the workload S130, when the first distributed node 110 is a distributed node included in the fully-distributed cloud, the server 200 may receive the workload status of the first distributed node 110 from the first distributed node.

Meanwhile, in the step S150 of preparing in advance the second distributed node 120, the server 200 may prepare in advance at least one second distributed node 120 to assist or replace the first distributed node 110 according to the result of monitoring.

Here, the second distributed node 120 may be selected from a pre-provisioned distributed node pool of the hybrid AI cloud system, or may be selected from distributed nodes of the external cloud system.

Further, preparing the at least one second distributed node 120 in advance may include setting the second distributed node 120 to be in a standby state having AI execution environment information of the first distributed node 110.

In addition, the preparing of the second distributed node in advance (S150) may include a step of preparing the second distributed node 120 in advance when the number of nodes lacking performance to execute the AI service among the first distributed nodes 110 is reduced to be less than or equal to a preset threshold value and the workload dynamically increases during a peak time.

In addition, the method for providing and managing the hybrid AI service according to the present embodiment may further include, before the monitoring of the workload S130, the steps of including the AI service request R in the AI service queue Q when the AI service request is received, selecting the first distributed node 110 to perform the AI service request R pending in the AI service queue Q, and transferring the AI service request to the execution queue Q-110 of the first distributed node 110 to be executed in the first distributed node 110.

The hybrid AI service providing and managing method of the present disclosure may be implemented in the form of program instructions that may be executed through various computer components and recorded in a computer-readable recording medium. The computer-readable recording medium may include program instructions, data files, data structures, and the like alone or in combination.

The program instructions recorded in the computer-readable recording medium may be specially designed and configured for the present disclosure or may be known to and used by those skilled in the field of computer software.

Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions such as a ROM, a RAM, a flash memory, and the like.

Examples of program instructions include not only machine language codes such as those generated by a compiler, but also high-level language codes that may be executed by a computer using an interpreter or the like. The hardware device may be configured to operate as one or more software modules to perform processing according to the present disclosure, and vice versa.

Although various embodiments of the present disclosure have been illustrated and described above, the present disclosure is not limited to the specific embodiments described above, and various modifications can be made by a person skilled in the art to which the present disclosure belongs without departing from the gist of the present disclosure claimed in the claims, and such modifications should not be individually understood from the technical spirit or the prospect of the present disclosure.

### DESCRIPTION OF SYMBOLS

10: Hybrid AI cloud system
100: Distributed node
200: Hybrid server

What is claimed is:

1. A hybrid AI cloud system comprising:
at least one distributed node configured to execute an artificial intelligence (AI) service; and
a hybrid server configured to:
monitor a workload of a first distributed node configured to execute the AI service, and
prepare in advance at least one second distributed node configured to assist or replace the first distributed node according to a result of the monitoring,
wherein the at least one second distributed node is selected from a previously prepared distributed node pool including distributed nodes of the hybrid AI cloud system, or from a distributed node of an external cloud system.

2. The hybrid AI cloud system of claim 1, wherein the preparing of the at least one second distributed node comprises setting the at least one second distributed node to be in a standby state equipped with AI execution environment information of the first distributed node.

3. The hybrid AI cloud system of claim 1, wherein the hybrid server prepares the at least one second distributed node in advance when a number of nodes that lack performance to execute the AI service among the first distributed nodes decreases to a preset threshold value or below, and the workload dynamically increases during a peak time.

4. The hybrid AI cloud system of claim 1, wherein the hybrid server receives a workload status from the first distributed node when the first distributed node is a distributed node included in a fully-distributed cloud.

5. The hybrid AI cloud system of claim 1, wherein the hybrid server selects the first distributed node to perform an AI service request pending in an AI service queue, and delivers the AI service request to an execution queue of the first distributed node for execution by the first distributed node.

6. A method for providing and managing a hybrid artificial intelligence (AI) service in a hybrid AI cloud system, the method comprising:
preparing at least one distributed node configured to execute an AI service;
monitoring a workload of a first distributed node configured to execute the AI service; and
preparing in advance at least one second distributed node configured to assist or replace the first distributed node according to a result of the monitoring,
wherein the at least one second distributed node is selected from a previously prepared distributed node pool including distributed nodes of the hybrid AI cloud system, or from a distributed node of an external cloud system.

7. The method of claim 6, wherein the preparing of the at least one second distributed node in advance comprises setting the at least one second distributed node to be in a standby state equipped with AI execution environment information of the first distributed node.

8. The method of claim 6, wherein the preparing of the at least one second distributed node in advance comprises preparing the at least one second distributed node in advance when a number of nodes that lack performance to execute the AI service among the first distributed nodes decreases to a preset threshold value or below, and the workload dynamically increases during a peak time.

9. The method of claim 6, wherein the monitoring of the workload of the first distributed node comprises receiving a workload status of the first distributed node from the first distributed node when the first distributed node is a distributed node included in a fully-distributed cloud.

10. The method of claim 6, further comprising:
prior to the monitoring of the workload, including an AI service request in an AI service queue when the AI service request is received;
selecting the first distributed node to perform the AI service request pending in the AI service queue; and
delivering the AI service request to an execution queue of the first distributed node for execution by the first distributed node.
